(19) United States
(12) Patent Application Publication
(10) Pub. No.: US 2026/0149536 A1
(43) Pub. Date: May 28, 2026

(54) IMPROVED RADIO ACCESS NETWORK (RAN) REDUNDANCY

(71) Applicant: Telefonaktiebolaget LM Ericsson (publ), Stockholm (SE)

(72) Inventor: Seunghee Yi, Seoul (KR)

(21) Appl. No.: 19/121,509

(22) PCT Filed: Nov. 18, 2022
(86) PCT No.: PCT/EP2022/082480

§ 371 Date: Apr. 16, 2025

(51) Int. Cl. H04L 1/22; H04B 1/74; H04W 24/04

(52) U.S. Cl. CPC H04L 1/22; H04B 1/74; H04W 24/04

(57) ABSTRACT

Methods and Radio Access Network (RAN) nodes for improved RAN redundancy. A method at a first RAN node for enabling redundancy with multiple active instances comprises: triggering multiple instances for the first RAN node to be active simultaneously, such that a processing load at the first RAN node can be distributed among the multiple instances and a part of the processing load handled by an instance of the multiple instances can be taken over by at least one other instance of the multiple instances when the instance fails.

### TECHNICAL FIELD

The present disclosure is related to the field of telecommunication, and in particular, to methods and radio access network (RAN) nodes for improved RAN redundancy.

### BACKGROUND

With the development of the electronic and telecommunications technologies, mobile devices, such as a mobile phone, a smart phone, a laptop, a tablet, a vehicle mounted device, becomes an important part of our daily lives. To support a numerous number of mobile devices, a highly efficient and robust RAN is needed, such as a Next Generation-RAN (NG-RAN), will be required.

The NG-RAN represents the newly defined radio access network for 5G. NG-RAN provides both New Radio (NR) and Long Term Evolution (LTE) radio access. An NG-RAN node (i.e. base station) is:
a gNB (i.e. a 5G base station), providing NR user plane and control plane services; or
a ng-eNB, providing LTE/Evolved Universal Terrestrial Radio Access Network (E-UTRAN) services towards the user equipment (UE).

The gNBs and ng-eNBs are interconnected with each other by means of the Xn interface. The gNBs and ng-eNBs are also connected by means of the NG interfaces to the 5G Core (5GC), more specifically to the AMF (Access and Mobility Management Function) by means of the NG-C interface and to the UPF (User Plane Function) by means of the NG-U interface.

The 4G RAN architecture was based on a “monolithic” building block, the eNB. This resulted in a very simple RAN architecture, where few interactions between logical nodes need to be specified. By contrast, splitting up the gNB (the NR logical node) between Central Units (CUs) and Distributed Units (DUs) would bring additional benefits.

A gNB may then consist of a gNB-CU and one or more gNB-DU(s), and the interface between gNB-CU and gNB-DU is called F1. The NG and Xn-C interfaces for a gNB terminate in the gNB-CU. The maximum number of gNB-DUs connected to a gNB-CU is only limited by implementation. In 3^{rd} Generation Partnership Project (3GPP) standard, one gNB-DU connects to only one gNB-CU, but implementations that allow multiple gNB-CUs to connect to a single gNB-DU e.g. for added resiliency, are not precluded. One gNB-DU may support one or more cells. The internal structure of the gNB is not visible to the core network and other RAN nodes, so the gNB-CU and connected gNB-DUs are only visible to other gNBs and the 5GC as a gNB.

To optimize the location of different RAN functions according to different scenarios and performance requirements, the gNB-CU can be further separated into its Control Plane (CP) and User Plane (UP) parts (the gNB-CU-CP and gNB-CU-UP, respectively).

The interface between CU-CP and CU-UP is called E1 (purely a control plane interface). The gNB-CU-CP hosts the RRC and the control plane part of the Packet Data Convergence Protocol (PDCP) protocol; it also terminates the E1 interface connected with the gNB-CU-UP and the F1-C interface connected with the gNB-DU. The gNB-CU-UP hosts the user plane part of the PDCP protocol of the gNB-CU for an en-gNB, and the user plane part of the PDCP protocol and the Service Data Adaptation Protocol (SDAP) protocol of the gNB-CU for a gNB. The gNB-CU-UP terminates the E1 interface connected with the gNB-CU-CP and the F1-U interface connected with the gNB-DU.

### SUMMARY

According to a first aspect of the present disclosure, a method at a first RAN node for enabling redundancy with multiple active instances is provided. The method comprises: triggering multiple instances for the first RAN node to be active simultaneously, such that a processing load at the first RAN node can be distributed among the multiple instances and a part of the processing load handled by an instance of the multiple instances can be taken over by at least one other instance of the multiple instances when the instance fails.

In some embodiments, for a reference point between the first RAN node and another RAN node, the multiple instances comprise at least one of: a first instance that handles, as a master, both UE associated signaling and non-UE associated signaling for the reference point; and one or more second instances that handle only UE associated signaling for the reference point. In some embodiments, one of the multiple instances is a master for a first reference point while another of the multiple instances is a master for a second reference point. In some embodiments, for a reference point between the first RAN node and another RAN node, each of the multiple instances for the first RAN node is associated with at least one network address for communicating with the other RAN node via the reference point.

In some embodiments, the step of triggering multiple instances for the first RAN node to be active comprises: determining whether a number of currently active instances is less than a predetermined or configured value or not; and triggering at least one new instance for the first RAN node to be active in response to determining that the number of active instances is less than the predetermined or configured value. In some embodiments, the predetermined or configured value is more than 2. In some embodiments, after the step of triggering at least one new instance for the first RAN node to be active, the method further comprises: transmitting, to each of one or more second RAN nodes, a first message indicating that a network address associated with the new instance is to be added at the corresponding second RAN node for the corresponding second RAN node to communicate with the first RAN node. In some embodiments, the first message further indicates one of: the network address associated with the new instance is used for UE associated signaling only when the new instance is not a master; and the network address associated with the new instance is used for both UE associated signaling and non-UE associated signaling when the new instance is the master. In some embodiments, the first message is transmitted by a first instance that handles, as a master, both UE associated signaling and non-UE associated signaling for a reference point between the first RAN node and the corresponding second RAN node. In some embodiments, when the new instance is an instance that is recovered from its previous failure, the first message indicates that the network address associated with the new instance is used for UE associated signaling only no matter whether the new instance was previously a master or not.

In some embodiments, when the first RAN node is a gNB-CU-CP and the one or more second RAN nodes comprise a gNB-CU-UP, the first message transmitted to the gNB-CU-UP is a GNB-CU-CP CONFIGURATION UPDATE message having a “TNLA Usage” Information Element (IE) with a value of “ue” for the network address associated with the new instance. In some embodiments, when the first RAN node is a gNB-CU-CP and the one or more second RAN nodes comprise a gNB-DU, the first message transmitted to the gNB-DU is a GNB-CU CONFIGURATION UPDATE message having a “TNLA Usage” IE with a value of “ue” for the network address associated with the new instance.

In some embodiments, the method further comprises: performing one or more operations between the multiple instances, the one or more operations comprising at least one of: synchronizing user data comprising UE contexts; monitoring peer's state; and internal routing for Next Generation Application Protocol (NGAP) data. In some embodiments, the one or more operations are performed via a synchronization channel between the multiple instances. In some embodiments, the method further comprises: determining whether a first instance and/or a network interface associated with the first instance fails or not, the first instance handling, as a master, both UE associated signaling and non-UE associated signaling for the network interface; and triggering a second instance to function as the master and take over the non-UE associated signaling handled by the first instance in response to determining that the first instance and/or the network interface associated with the first instance fails. In some embodiments, the step of triggering the second instance to function as the master and take over the non-UE associated signaling handled by the first instance comprises: transmitting, to each of one or more second RAN nodes, a second message indicating that a network address associated with the second instance, which was used for UE associated signaling only, is updated to be used for both UE associated signaling and non-UE associated signaling. In some embodiments, the second message is transmitted by the second instance that is triggered to function as the master.

In some embodiments, when the first RAN node is a gNB-CU-CP and the one or more second RAN nodes comprise a gNB-CU-UP, the second message transmitted to the gNB-CU-UP is a GNB-CU-CP CONFIGURATION UPDATE message having a “TNLA Usage” IE with a value of “both” for the network address associated with the second instance. In some embodiments, when the first RAN node is a gNB-CU-CP and the one or more second RAN nodes comprise a gNB-DU, the second message transmitted to the gNB-DU is a GNB-CU CONFIGURATION UPDATE message having a “TNLA Usage” IE with a value of “both” for the network address associated with the second instance. In some embodiments, the method further comprises: transmitting, to a core network (CN) node, a third message indicating that UE contexts associated with the first RAN node are to be retained by the CN node. In some embodiments, the third message is transmitted by the second instance that is triggered to function as the master and is an NG SETUP REQUEST message having a “UE Retention Information” IE with a value of “ues-retained”.

According to a second aspect of the present disclosure, a first RAN node is provided. The first RAN node comprises: a processor; a memory storing instructions which, when executed by the processor, cause the processor to perform any of the methods of the first aspect. In some embodiments, the first RAN node is a gNB-CU-CP.

According to a third aspect of the present disclosure, a first RAN node for enabling redundancy with multiple active instances is provided. The first RAN node comprises: a triggering module configured to trigger multiple instances for the first RAN node to be active simultaneously, such that a processing load at the first RAN node can be distributed among the multiple instances and a part of the processing load handled by an instance of the multiple instances can be taken over by at least one other instance of the multiple instances when the instance fails. In some embodiments, the first RAN node comprises one or more further modules, each of which may perform any of the steps of any of the methods of the first aspect.

According to a fourth aspect of the present disclosure, a method at a second RAN node for facilitating a first RAN node in enabling redundancy with multiple active instances is provided. The method comprises: communicating with at least one of multiple instances for the first RAN node that are active simultaneously, to enable the first RAN node to distribute its processing load among the multiple instances and a part of the processing load handled by an instance of the multiple instances can be taken over by at least one other instance of the multiple instances when the instance fails.

In some embodiments, for a reference point between the first RAN node and the second RAN node, the multiple instances comprise at least one of: a first instance that handles, as a master, both UE associated signaling and non-UE associated signaling for the reference point; and one or more second instances that handle only UE associated signaling for the reference point. In some embodiments, one of the multiple instances is a master for a first reference point while another of the multiple instances is a master for a second reference point. In some embodiments, for a reference point between the first RAN node and the second RAN node, each of the multiple instances for the first RAN node is associated with at least one network address for communicating with the second RAN node via the reference point. In some embodiments, the number of the multiple instances is 2. In some embodiments, the method further comprises: receiving, from the first RAN node, a first message indicating that a network address associated with a new instance for the first RAN node is to be added at the second RAN node for the second RAN node to communicate with the first RAN node.

In some embodiments, the first message further indicates one of: the network address associated with the new instance is used for UE associated signaling only when the new instance is not a master; and the network address associated with the new instance is used for both UE associated signaling and non-UE associated signaling when the new instance is the master. In some embodiments, the first message is transmitted by a first instance that handles, as a master, both UE associated signaling and non-UE associated signaling for a reference point between the first RAN node and the second RAN node. In some embodiments, when the new instance is an instance that is recovered from its previous failure, the first message indicates that the network address associated with the new instance is used for UE associated signaling only no matter whether the new instance was previously a master or not. In some embodiments, when the first RAN node is a gNB-CU-CP and the second RAN node is a gNB-CU-UP, the first message is a GNB-CU-CP CONFIGURATION UPDATE message having a “TNLA Usage” IE with a value of “ue” for the network address associated with the new instance. In some embodiments, when the first RAN node is a gNB-CU-CP and the second RAN node is a gNB-DU, the first message is a GNB-CU CONFIGURATION UPDATE message having a “TNLA Usage” IE with a value of “ue” for the network address associated with the new instance.

In some embodiments, the method further comprises: receiving, from the first RAN node, a second message indicating that a network address associated with a second instance, which was used for UE associated signaling only, is updated to be used for both UE associated signaling and non-UE associated signaling. In some embodiments, the second message is transmitted by the second instance. In some embodiments, when the first RAN node is a gNB-CU-CP and the second RAN node is a gNB-CU-UP, the second message is a GNB-CU-CP CONFIGURATION UPDATE message having a “TNLA Usage” IE with a value of “both” for the network address associated with the second instance. In some embodiments, when the first RAN node is a gNB-CU-CP and the second RAN node is a gNB-DU, the second message is a GNB-CU CONFIGURATION UPDATE message having a “TNLA Usage” IE with a value of “both” for the network address associated with the second instance.

According to a fifth aspect of the present disclosure, a second RAN node is provided. The second RAN node comprises: a processor; a memory storing instructions which, when executed by the processor, cause the processor to perform any of the methods of the fourth aspect. In some embodiments, the second RAN node is a gNB-CU-UP or a gNB-DU.

According to a sixth aspect of the present disclosure, a second RAN node for facilitating a first RAN node in enabling redundancy with multiple active instances is provided. The second RAN node comprises: a communicating module configured to communicate with at least one of multiple instances for the first RAN node that are active simultaneously, to enable the first RAN node to distribute its processing load among the multiple instances and a part of the processing load handled by an instance of the multiple instances can be taken over by at least one other instance of the multiple instances when the instance fails. In some embodiments, the second RAN node comprises one or more further modules, each of which may perform any of the steps of any of the methods of the fourth aspect.

According to a seventh aspect of the present disclosure, a computer program comprising instructions is provided. In some embodiments, the instructions, when executed by at least one processor, cause the at least one processor to carry out the method of any of the first aspect and/or the fourth aspect.

According to an eighth aspect of the present disclosure, a carrier containing the computer program of the seventh aspect is provided. In some embodiments, the carrier is one of an electronic signal, optical signal, radio signal, or computer readable storage medium.

According to a ninth aspect of the present disclosure, a telecommunication system is provided. The telecommunication system comprises: one or more first RAN nodes of the second or third aspect; and one or more second RAN nodes of the fifth or sixth aspect.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a block diagram illustrating an exemplary telecommunication network in which improved RAN redundancy may be applicable according to an embodiment of the present disclosure.

FIG. 2 is a diagram illustrating an exemplary gNB in which improved RAN redundancy may be applicable according to an embodiment of the present disclosure.

FIG. 3 is a diagram illustrating an exemplary gNB in which improved RAN redundancy may be applicable according to an embodiment of the present disclosure.

FIG. 4 is a diagram illustrating an exemplary gNB with multiple active instances according to an embodiment of the present disclosure.

FIG. 5 is a diagram illustrating an exemplary gNB in which a part of the processing load handled by a failed instance is taken over by another active instance according to an embodiment of the present disclosure.

FIG. 6 is a diagram illustrating exemplary procedures for adding a network address associated with a new active instance according to an embodiment of the present disclosure.

FIG. 7 is a diagram illustrating an exemplary synchronization channel (or “sync-channel”) between multiple active instances according to an embodiment of the present disclosure.

FIG. 8A and FIG. 8B are diagrams illustrating exemplary procedures for handling a failed non-UE master according to an embodiment of the present disclosure.

FIG. 9 is a diagram illustrating exemplary scenarios before and after a new instance is activated according to an embodiment of the present disclosure.

FIG. 10 is a diagram illustrating exemplary scenarios before and after a failure event associated with a non-UE master is handled according to an embodiment of the present disclosure.

FIG. 11 is a diagram illustrating exemplary scenarios before and after an instance is recovered from a previous failure according to an embodiment of the present disclosure.

FIG. 12 is a flowchart illustrating an exemplary method for adding a new instance according to an embodiment of the present disclosure.

FIG. 13 is a flowchart illustrating an exemplary method for handling a failure event associated with a non-UE master according to an embodiment of the present disclosure.

FIG. 14 is a flow chart illustrating an exemplary method at a first RAN node for enabling redundancy with multiple active instances according to an embodiment of the present disclosure.

FIG. 15 is a flow chart illustrating an exemplary method at a second RAN node for facilitating a first RAN node in enabling redundancy with multiple active instances according to an embodiment of the present disclosure.

FIG. 16 schematically shows an embodiment of an arrangement which may be used in a first RAN node and/or a second RAN node according to an embodiment of the present disclosure.

FIG. 17 is a block diagram of an exemplary first RAN node according to an embodiment of the present disclosure.

FIG. 18 is a block diagram of an exemplary second RAN node according to an embodiment of the present disclosure.

FIG. 19 shows an example of a communication system in accordance with some embodiments of the present disclosure.

FIG. 20 shows an exemplary UE in accordance with some embodiments of the present disclosure.

FIG. 21 shows an exemplary network node in accordance with some embodiments of the present disclosure.

FIG. 22 is a block diagram of an exemplary host, which may be an embodiment of the host of FIG. 19, in accordance with various aspects described herein.

FIG. 23 is a block diagram illustrating an exemplary virtualization environment in which functions implemented by some embodiments may be virtualized.

FIG. 24 shows a communication diagram of an exemplary host communicating via an exemplary network node with an exemplary UE over a partially wireless connection in accordance with some embodiments of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, although the following description of some embodiments of the present disclosure is given in the context of 5G NR, the present disclosure is not limited thereto. In fact, as long as improved RAN redundancy is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an Internet of Things (IoT) device, a vehicle, or any other equivalents. For another example, the term “RAN node” used herein may refer to a base station, a base transceiver station, an access point, a hot spot, a NodeB (NB), an evolved NodeB (eNB), a gNB, a gNB-DU, a gNB-CU, a gNB-CU-CP, a gNB-CU-UP, or any other equivalents.

Further, when something is modified by the term “non-UE” or “non-UE associated”, it may be interpreted as follows: it is not associated with one or more specific UEs. For example, non-UE associated signaling may refer to signaling that is not associated with any specific UE. For another example, a non-UE master may refer to an instance that functions as a master for handling non-UE associated signaling.

Further, following 3GPP documents are incorporated herein by reference in their entireties:
3GPP TS 38.401 V16.6.0 (2021-July), Technical Specification, 3rd Generation Partnership Project; Technical Specification Group Radio Access Network; NG-RAN; Architecture description (Release 16);
3GPP TS 38.463 V16.6.0 (2021-July), Technical Specification, 3rd Generation Partnership Project; Technical Specification Group Radio Access Network; NG-RAN; E1 Application Protocol (E1AP) (Release 16);
3GPP TS 38.473 V16.10.0 (2022-June), Technical Specification, 3rd Generation Partnership Project; Technical Specification Group Radio Access Network; NG-RAN; F1 application protocol (F1AP) (Release 16); and
3GPP TS 38.413 V16.10.0 (2022-June), Technical Specification, 3rd Generation Partnership Project; Technical Specification Group Radio Access Network; NG-RAN; NG Application Protocol (NGAP) (Release 16).

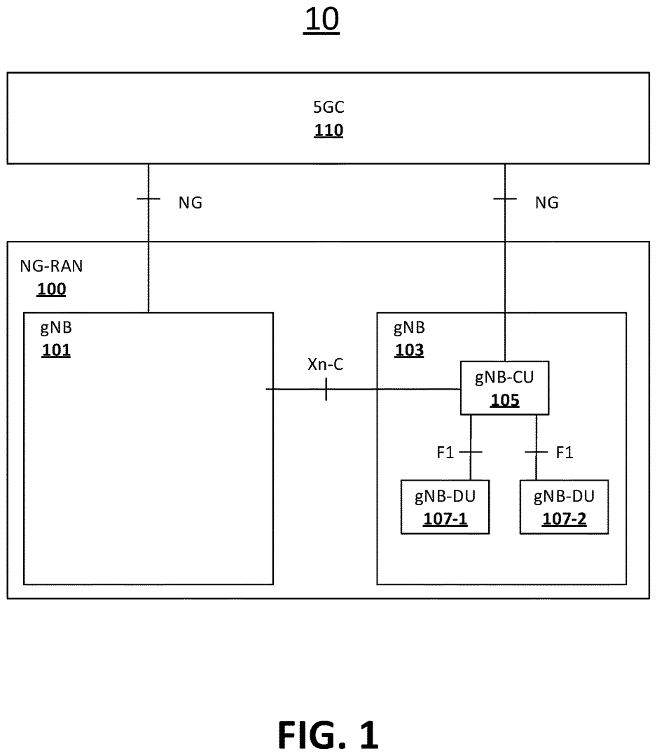

FIG. 1 is a block diagram illustrating an exemplary telecommunication network 10 in which improved RAN redundancy may be applicable according to an embodiment of the present disclosure. Although the telecommunication network 10 is a network defined in the context of 5G System (5GS), the present disclosure is not limited thereto.

As shown in FIG. 1, the network 10 may comprise an NG-RAN 100 and a 5GC 110. In some embodiments, the NG-RAN 100 may comprise one or more gNBs 101 and 103 which provide one or more UEs with access to other parts of the network 10. Although it is shown in FIG. 1 that the NG-RAN 100 comprises two gNBs 101 and 103, the present disclosure is not limited thereto. In some other embodiments, a single gNB or more than two gNBs may be comprised in the NG-RAN 100. Further, the NG-RAN 100 may comprise other AN nodes than gNBs 101 and 103, such as, ng-eNB or any other AN node which provide the one or more UEs with access to other parts of the network 10.

In some embodiments, the 5GC 110 may comprise (but not limited to) one or more of an Access and Mobility Management Function (AMF), a Session Management Function (SMF), a Policy Control Function (PCF), an Application Function (AF), a Network Slice Selection Function (NSSF), a Binding Support Function (BSF), a Unified Data Management (UDM), a Network Exposure Function (NEF), a Network Repository Function (NRF), and a User Plane Function (UPF). These entities may communicate with each other via the service-based interfaces, such as, Namf, Nsmf, Npcf, etc. and/or the reference points, such as, N1, N2, N3, N4, N6, N9, etc.

However, the present disclosure is not limited thereto. In some other embodiments, the network 10 may comprise additional network nodes, less network nodes, or some variants of the existing network functions shown in FIG. 1. For example, in a network with the 4G EPS architecture, the entities which perform these functions (e.g., Mobility Management Entity (MME)) may be different from that comprised in the 5GC 110 (e.g., the AMF). For another example, in a network with a mixed 4G/5G architecture, some of the entities may be same as those shown in FIG. 1 (e.g., a gNB 101 or 103), and others may be different (e.g., an eNB). Further, the functions shown in FIG. 1 are not essential to the embodiments of the present disclosure. In other words, some of them may be missing from some embodiments of the present disclosure.

As mentioned above and also shown in FIG. 1, the NG-RAN 100 may consist of a set of gNBs (e.g., gNB 101 and gNB 103) connected to the 5GC 110 through the NG interface. The gNBs 101 and 103 can be interconnected through the Xn interface. As shown in FIG. 1, the gNB 103 may consist of a gNB-CU 105 and one or more gNB-DU(s) 107-1 and 107-2 (collectively, gNB-DU 107 hereinafter). The gNB-CU 105 and the gNB-DU 107 may be connected via F1 interface.

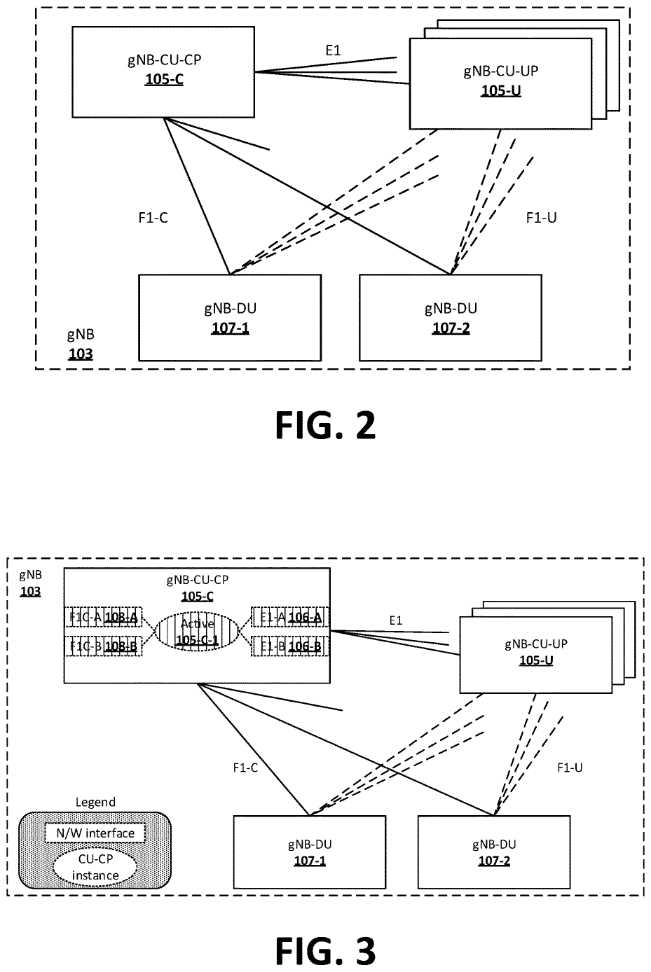

Additionally, the gNB-CU 105 can be decomposed into two parts: gNB-CU-CP for control plane and gNB-CU-UP for user plane. Both are interconnected via E1 interface as shown in FIG. 2. FIG. 2 is a diagram illustrating an exemplary gNB (e.g., the gNB 103 comprising the gNB-CU 105 and the gNB-DU 107 as shown in FIG. 1) in which improved RAN redundancy may be applicable according to an embodiment of the present disclosure. As shown in FIG. 2, the gNB-CU 105 comprised in the gNB 103 may comprise a gNB-CU-CP 105-C and one or more gNB-CU-UPs 105-U.

In some embodiments, the gNB-CU-CP 105-C may select the appropriate gNB-CU-UP(s) 105-U for the requested services for the UE. After selection of gNB-CU-UP, it is essential to exchange application-level data needed for the gNB-CU-CP 105-C and the gNB-CU-UP 105-U to correctly interoperate on the E1 interface. For this, the gNB-CU-CP 105-C may initiate the E1 Setup procedure by sending a GNB-CU-CP E1 SETUP REQUEST message and then it may be replied with a GNB-CU-CP E1 SETUP RESPONSE message from the gNB-CU-UP 105-U.

In the similar way, the gNB-DU 107 may select the appropriate gNB-CU-CP 105-C for the UE service. After selection of gNB-CU-CP, it is essential to exchange application-level data needed for the gNB-DU 107 and the gNB-CU-CP 105-C to correctly interoperate on the F1-C interface. For this, the gNB-DU 107 may initiate the F1 Setup procedure by sending an F1 SETUP REQUEST message and then it may be replied with an F1 SETUP RESPONSE message from the gNB-CU-CP 105-C.

In some embodiments of the present disclosure, all the explanations are described in NR Standalone (SA) perspective. However, the similar mechanism/behavior can be applicable to NR Non-Standalone (NSA) as well.

Typically, a gNB (gNodeB) may be implemented on the special hardware (HW) platform (Physical Network Function or PNF). Even though there are several gNB variants, they do not support any resilience mechanism. However it is not a big problem because gNB's capacity is not big enough. On the contrary, in new type of gNB based on Cloud (Cloud Network Function or CNF), gNB's capacity is very variable and high according to the operator's needs. If there is any failure in the cloud-based gNB with the high capacity, the impact is not negligible any more. Therefore, it is essential to support resilience mechanism (e.g., dual-active redundancy with load-sharing) for the cloud-based gNB. If there is a failure on the active instance in a gNB-CU-CP, then the role for non-UE associated signaling shall be taken over to the other active instance completely.

Currently, 3GPP standard for E1 and F1-C interface supports multiple E1/F1-C endpoints. It can be useful for the network failure on each interface. However, there is no consideration for the gNB-CU-CP's redundancy.

FIG. 3 is a diagram illustrating an exemplary gNB in which improved RAN redundancy may be applicable according to an embodiment of the present disclosure. As shown in FIG. 3, the gNB-CU-CP 105-C may have one active instance 105-C−1 and multiple network interfaces (or associated network addresses) for each of reference points, such as, E1-A 106-A and E1-B 106-B for the reference point E1 and F1C-A 108-A and F1C-B 108-B for the reference point F1-C.

For the better resilience in the gNB-CU-CP 105-C, two kinds of resilience may be required-one for network interface, and the other for gNB-CU-CP instance. Therefore, in some embodiments of the present disclosure, a solution with the two kinds of resilience will be proposed. In some embodiments, for the full redundancy in gNB-CU-CP, there may be two or more CU-CP instances and each instance may have its own E1/F1-C network interface respectively. Hereinafter, the terms “multi-active” and “multiple-active” may be used to refer to more than one active instance at the same time, and can be used interchangeably. Further, although only “dual active” embodiments are described in the following embodiments, the present disclosure is not limited thereto. In some other embodiments, more than two active instances may be present simultaneously.

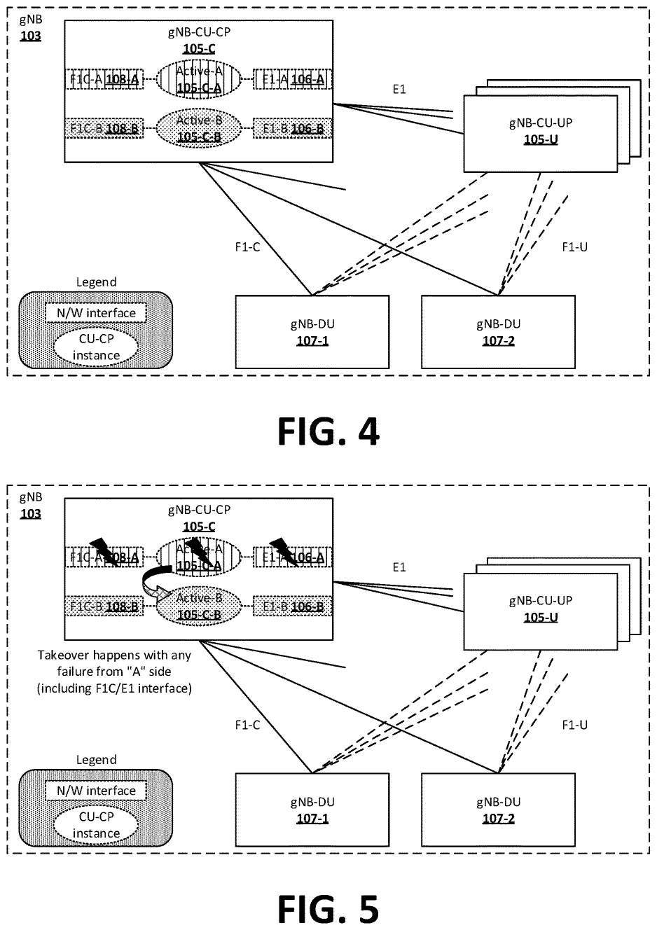

FIG. 4 is a diagram illustrating an exemplary gNB 103 with multiple active instances according to an embodiment of the present disclosure. As shown in FIG. 4, the gNB-CU-CP 105-C may have multiple active instances, e.g., an active instance A (or Active-A) 105-C-A and an active instance B (or Active-B) 105-C-B, and each of the active instances may have its own associated network interfaces (and/or network addresses) for various reference points (e.g., E1 and/or F1-C). For example, the Active-A 105-C-A may be associated with an E1 interface E1-A 106-A and an F1-C interface F1C-A 108-A. For another example, the Active-B 105-C-B may be associated with an E1 interface E1-B 106-B and an F1-C interface F1C-B 108-B. Therefore, the active instances of the gNB-CU-CP 105-C may communicate with other nodes separately. For example, the Active-A 105-C-A may communicate with the gNB-CU-UP 105-U via the E1-A 106-A while the Active-B 105-C-B may communicate with the gNB-CU-UP 105-U via the E1-B 106-B. However, from the perspective of the gNB-CU-UP 105-U, it only sees a same gNB-CU-CP 105-C with multiple network interfaces and/or multiple network addresses. That is, from the perspective of the external nodes (e.g., the gNB-CU-UP 105-U or the gNB-DU 107), the gNB-CU-CP 105-C seems to be a high capacity node with multiple E1/F1-C interfaces and each gNB-CU-CP instance is not visible by the external nodes.

In some embodiments, when the addition of gNB-CU-CP instance or failure of gNB-CU-CP instance/network interface happens, to support the dual-active redundancy, the below procedures may be triggered to handle the change in E1/F1-C interface after successful Setup procedure initially:
GNB-CU-CP Configuration Update procedure (E1);
GNB-CU Configuration Update procedure (F1-C).

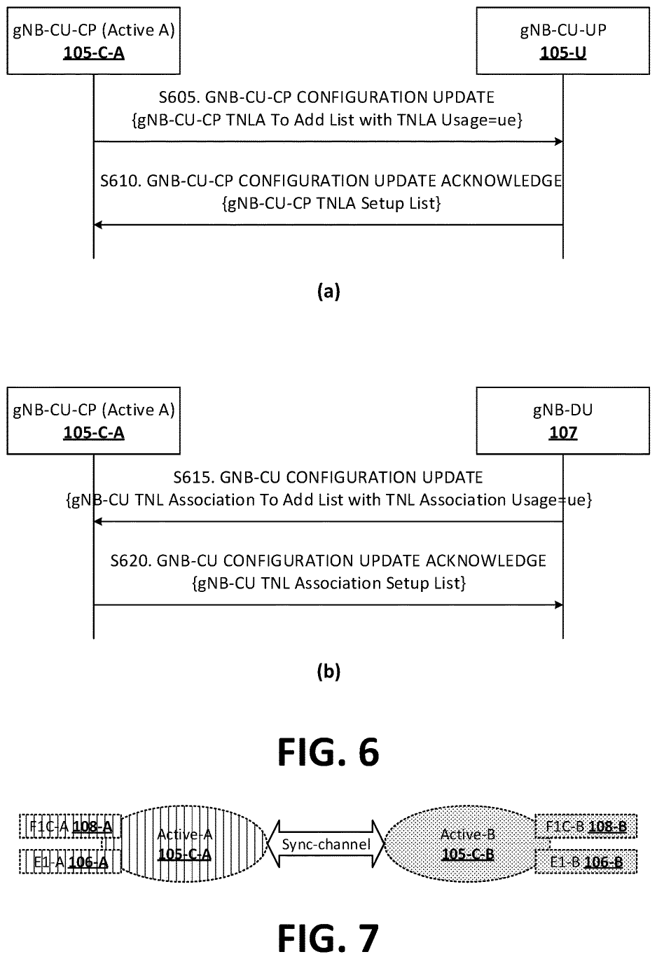

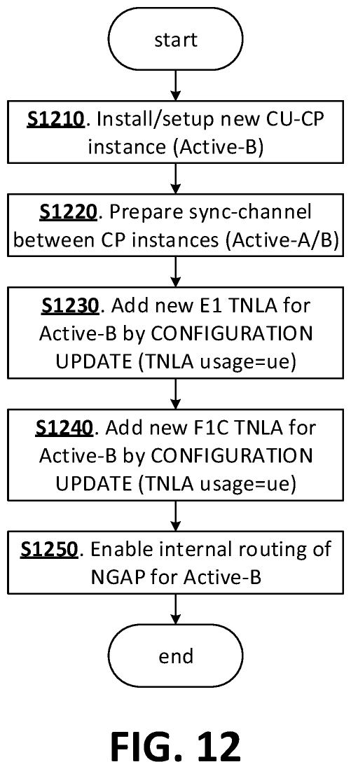

In some embodiments, when additional gNB-CU-CP instance is newly added, a GNB-CU-CP Configuration Update procedure may be triggered to add new E1 TNLA. For the F1-C, a GNB-CU Configuration Update procedure may be triggered as well to add new F1-C TNLA. The detailed procedure will be described below with reference to FIG. 6, 7, FIG. 9, and FIG. 12.

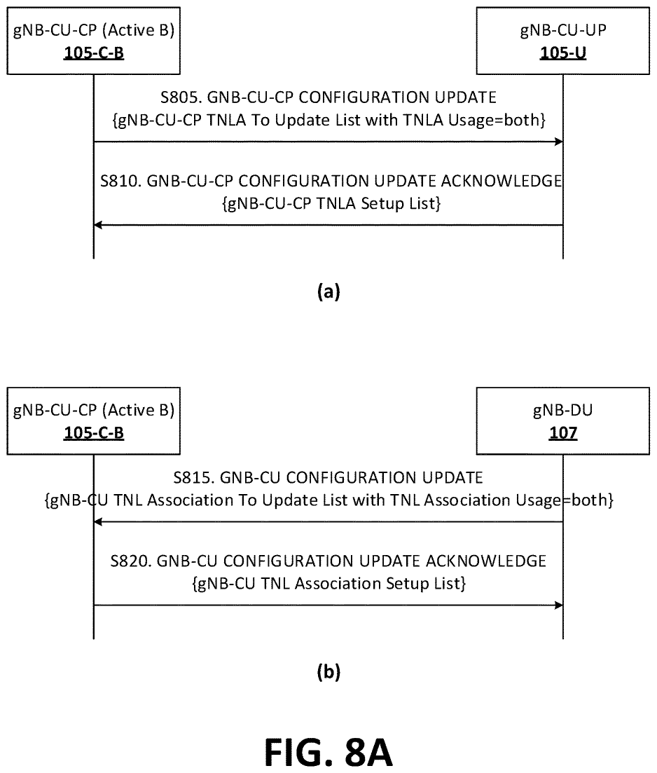

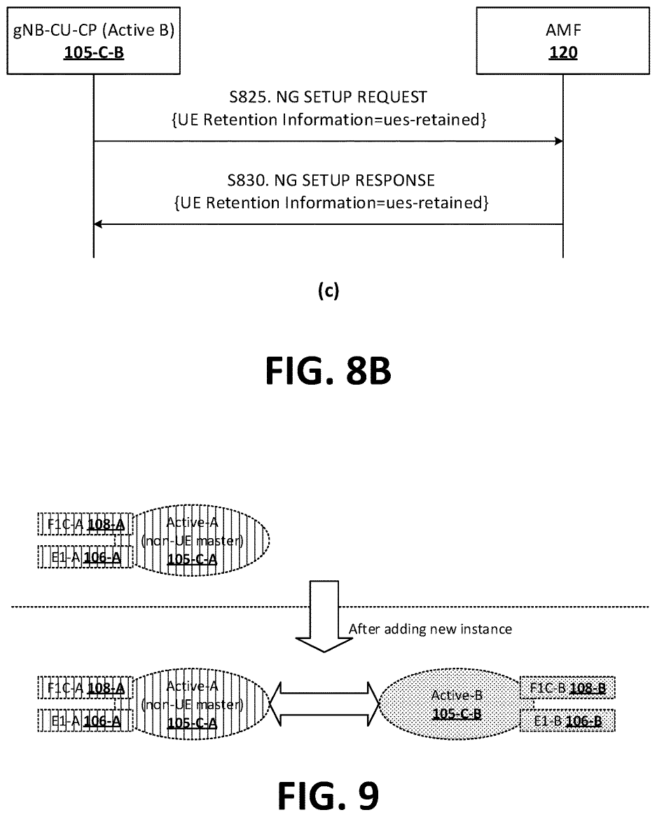

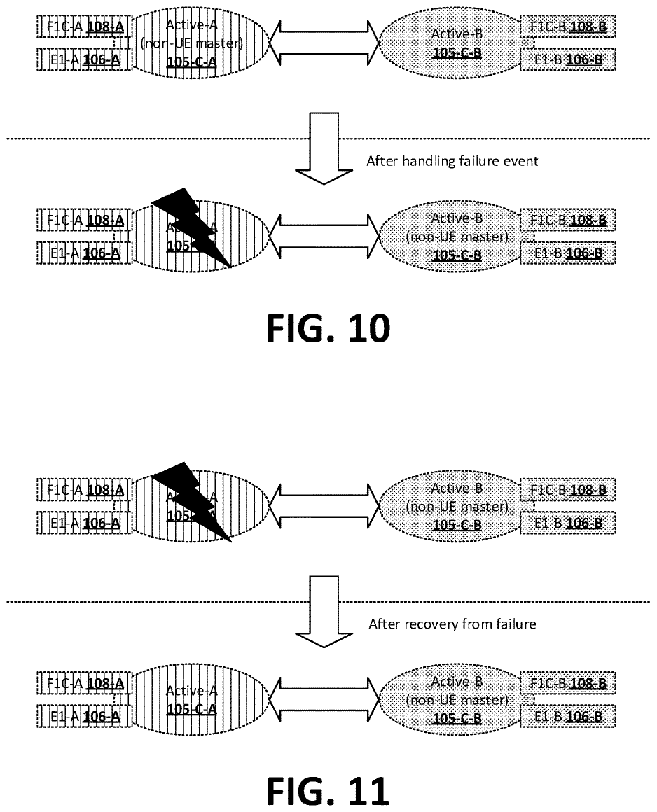

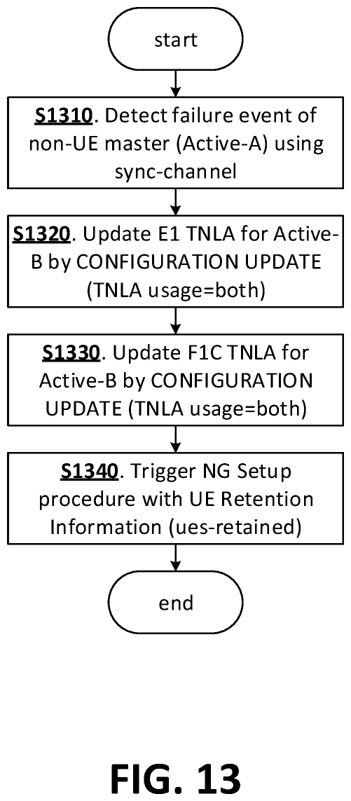

In some embodiments, as shown in FIG. 5, when any failure (e.g., network interface or gNB-CU-CP instance) in the master of non-UE signaling happens, a takeover action may be initiated by the other gNB-CU-CP instance by both GNB-CU-CP Configuration Update (E1) and GNB-CU Configuration Update (F1-C) procedures. FIG. 5 is a diagram illustrating an exemplary gNB 103 in which a part of the processing load handled by a failed instance, Active-A 105-C-A, is taken over by another active instance, Active-B 105-C-B, according to an embodiment of the present disclosure. As shown by FIG. 5, when the Active-A 105-C-A (or the non-UE master) fails, the other active instance Active-B 105-C-B may take over the processing load (or role), which is previously handled by the Active-A 105-C-A, and function as the new non-UE master for the gNB-CU-CP 105-C. The detailed procedure will be described below with reference to FIG. 8A, FIG. 8B, FIG. 10, FIG. 11, and FIG. 13.

With some embodiments of the present disclosure, it is possible to support resilience from node/network failure in gNB-CU-CP to keep the existing UE contexts. Different from “active-standby” redundancy, some embodiments of the present disclosure can share the load of handling UEs during normal operation, and when the failure event happens in the master of non-UE associated signaling, such a role can be taken over by the other side gracefully. Further, in the cloud-based gNB, which has high capacity compared with the legacy gNB (PNF), if the existing contexts are lost in gNB, a lot of UEs/services are out of service. This problem can be solved or at least alleviated by the dual-active redundancy in gNB-CU-CP.

FIG. 6 is a diagram illustrating exemplary procedures for adding a network address associated with a new active instance according to an embodiment of the present disclosure. As shown in FIG. 9, initially, there may be only a single instance (e.g., the Active-A 105-C-A) within the gNB-CU-CP 105-C. For the “dual-active” redundancy, the operator may add a new gNB-CU-CP instance (e.g., the Active-B 105-C-B) as also shown in FIG. 9. Then a new TNLA for E1/F1-C may be informed using Configuration Update procedure.

Referring back to the procedure shown in (a) of FIG. 6, for the E1 reference point, the gNB-CU-CP (Active-A side) 105-C-A may send at step S605 a GNB-CU-CP CONFIGURATION UPDATE message to the gNB-CU-UP 105-U with “Add List-TNLA Usage=ue”, and then it may be replied at step S610 with a GNB-CU-CP CONFIGURATION UPDATE ACKNOWLEDGE by the gNB-CU-UP 105-U. In this state, the gNB-CU-CP (Active-A) 105-C-A can handle both non-UE associated and UE-associated signaling for E1, while the gNB-CU-CP (Active-B) 105-C-B can handle only UE-associated signaling for E1.

As shown in (b) of FIG. 6, for the F1-C reference point, the gNB-CU-CP (Active-A side) 105-C-A may send at step S615 a GNB-CU CONFIGURATION UPDATE message to the gNB-DU 107 with “Add List-TNL Association Usage=ue”, and then it may be replied at step S620 with a GNB-CU CONFIGURATION UPDATE ACKNOWLEDGE by the gNB-DU 107. In this state, the gNB-CU-CP (Active-A) 105-C-A can handle both non-UE associated and UE-associated signaling for F1-C, while the gNB-CU-CP (Active-B) 105-C-B can handle only UE-associated signaling for F1-C.

Further, a sync-channel may be established between the multiple active instances, for example, as shown in FIG. 7. FIG. 7 is a diagram illustrating an exemplary sync-channel between the multiple active instances according to an embodiment of the present disclosure. When a new gNB-CU-CP instance (e.g., the Active-B 105-C-B) is added (e.g., as shown in FIG. 6), synchronization is typically required between the two instances for the “dual-active” redundancy. In some embodiments, such a sync-channel may be used for at least one of:
Synchronizing user data including UE contexts;
Monitoring the peer's state (detect any failure);
Internal routing for NGAP (because multiple TNLAs for NGAP in NG-RAN side are not supported).

In some embodiments, a single sync-channel may be established for all the active instances. In some other embodiments, multiple sync-channels may be established for all the active instances.

FIG. 8A and FIG. 8B are diagrams illustrating exemplary procedures for handling a failed non-UE master according to an embodiment of the present disclosure. In some embodiments, regardless of multiple TNLAs for E1/F1-C, non-UE associated signaling shall be handled by one of them. Therefore, if there is any failure (network interface or gNB-CU-CP instance) on non-UE master side, such a non-UE associated signaling role shall be taken over the other side, as shown in FIG. 10.

In some embodiments, it will be possible to support cross non-UE master for E1/F1-C. For example, the Active-A 105-C-A may be a non-UE master for E1 and the Active-B 105-C-B may be a non-UE master for F1-C. However, for the simple explanation of the behavior, assuming the same side of non-UE master for E1/F1-C in the following embodiments, and the present disclosure is not limited thereto.

When a failure event happens in the non-UE signaling master (e.g., the Active-A 105-C-A), the other instance (e.g., the Active-B 105-C-B) may take over non-UE associated signaling for E1/F1-C using the Configuration Update procedure.

As shown in (a) of FIG. 8A, for the E1 reference point, the gNB-CU-CP (Active-B side) 105-C-B may send at step S805 a GNB-CU-CP CONFIGURATION UPDATE message to the gNB-CU-UP 105-U with “Update List-TNLA Usage=both”, and then it may be replied at step S810 with a GNB-CU-CP CONFIGURATION UPDATE ACKNOWLEDGE by the gNB-CU-UP 105-U. In this state, the gNB-CU-CP (Active-B) 105-C-B can handle both non-UE associated and UE-associated signaling for E1.

As shown in (b) of FIG. 8A, for the F1-C reference point, the gNB-CU-CP (Active-B side) 105-C-B may send at step S815 a GNB-CU CONFIGURATION UPDATE message to the gNB-DU 107 with “Update List-TNL Association Usage=both”, and then it may be replied at step S820 with a GNB-CU CONFIGURATION UPDATE ACKNOWLEDGE by the gNB-DU 107. In this state, the gNB-CU-CP (Active-B) 105-C-B can handle both non-UE associated and UE-associated signaling for F1-C.

Different from E1/F1-C, multiple TNLAs on NG-RAN side in NGAP is not supported in the 3GPP standard (while AMF side supports it). Therefore, as shown in (c) of FIG. 8B, the gNB-CU-CP (Active-B side) 105-C-B may send at step S825 an NG SETUP REQUEST message to an AMF 120 with “UE Retention Information=ues-retained” (to keep the existing UE contexts), and then it may be replied at step S830 with an NG SETUP RESPONSE by the AMF 120. In this state, reasonably gNB-CU-CP (Active-B) 105-C-B can handle both non-UE associated and UE-associated signaling for NG-C.

In some embodiments, if the failure happens in the other side of non-UE master (e.g., an instance that is not a non-UE master), then CONFIGURATION UPDATE procedure is not required. In such a case, the only operation needed is to update a TNLA binding within each node to handle the existing UE context continually.

FIG. 11 is a diagram illustrating exemplary scenarios before and after an instance (e.g., the Active-A 105-C-A) is recovered from a previous failure according to an embodiment of the present disclosure. As shown in FIG. 11, even though the gNB-CU-CP (A side) 105-C-A is recovered from the previous failure, the gNB-CU-CP (B side) 105-C-B may keep the non-UE signaling master role. In case of the recovered gNB-CU-CP (A side) 105-C-A, it may be handled by the “Add new gNB-CU-CP instance” routine, as described above with reference to FIG. 6.

FIG. 12 is a flowchart illustrating an exemplary method for adding a new instance according to an embodiment of the present disclosure. As shown in FIG. 12, the method may start with step S1210 where a new CU-CP instance (e.g., the Active-B 105-C-B) may be installed and/or set up. At step S1220, a sync-channel may be prepared between the CU-CP instances (e.g., the Active-A 105-C-A and the Active-B 105-C-B) for subsequent usage. At steps S1230 and S1240, a new E1 TNLA and a new F1C TNLA may be added for the Active-B 105-C-B, for example, by the CONFIGURATION UPDATE procedures for E1 and F1C, respectively. In these procedures, the Active-B 105-C-B may be indicated as handling UE associated signaling only, for example, by a “TNLA Usage” IE with a value of “ue”. At step S1250, internal routing for NGAP between the active instances may be enabled for the Active-B 105-C-B. With the procedure shown in FIG. 12, a new instance may be activated.

FIG. 13 is a flowchart illustrating an exemplary method for handling a failure event associated with a non-UE master according to an embodiment of the present disclosure. As shown in FIG. 13, the method may start with step S1310 where a failure event of the non-UE master (e.g., the Active-A 105-C-A) may be detected by using the sync-channel. At steps S1320 and S1330, the E1 TNLA and the F1C TNLA associated with the Active-B 105-C-B may be updated such that they can be used as TNLAs for the non-UE master, for example, by the CONFIGURATION UPDATE procedures for E1 and F1C, respectively. In these procedures, the Active-B 105-C-B may be indicated as handling both non-UE associated signaling and UE associated signaling, for example, by a “TNLA Usage” IE with a value of “both”. At step S1340, an NG Setup procedure with UE retention information (ues-retained) may be triggered, such that the related information (e.g., UE contexts, service contexts) can be maintained for service continuity.

In the flowcharts shown by FIG. 12 and FIG. 13, the routines/tasks are very straight-forward. When a new gNB-CU-CP instance is added, a new TNLA for E1/F1-C may be used for “ue”-associated signaling. On the contrary, if any failure event in non-UE signaling master is detected, the other side may take over non-UE signaling master role for E1/F1-C using “both” indication in CONFIGURATION UPDATE procedure.

With the above embodiments, it is possible to support resilience from node/network failure in gNB-CU-CP to keep the existing UE contexts. Different from “active-standby” redundancy, some embodiments of the present disclosure can share the load of handling UEs during normal operation, and when the failure event happens in the master of non-UE associated signaling, such a role can be taken over by the other side gracefully. Further, in the cloud-based gNB, which has high capacity compared with the legacy gNB (PNF), if the existing contexts are lost in gNB, a lot of UEs/services are out of service. This problem can be solved or at least alleviated by the dual-active redundancy in gNB-CU-CP.

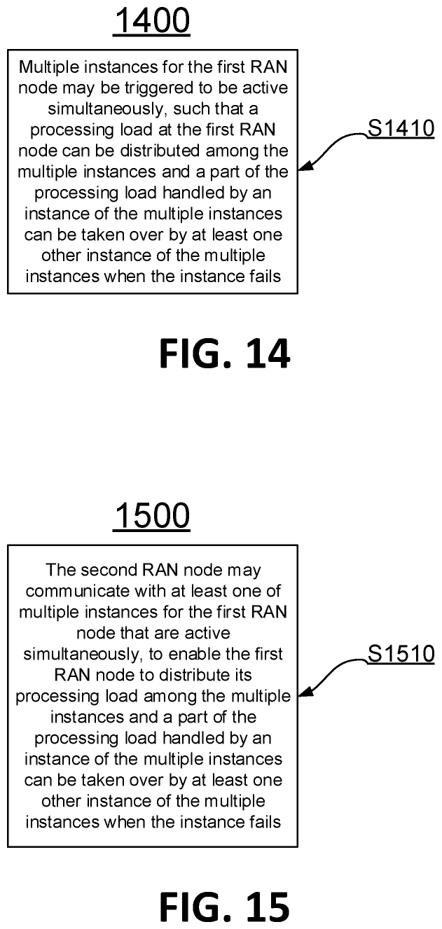

FIG. 14 is a flow chart illustrating an exemplary method 1400 at a first RAN node for enabling redundancy with multiple active instances according to an embodiment of the present disclosure. The method 1400 may be performed by a RAN node (e.g., the gNB-CU-CP 105-C). The method 1400 may comprise a step S1410. However, the present disclosure is not limited thereto. In some other embodiments, the method 1400 may comprise more steps, different steps, or any combination thereof. Further the steps of the method 1400 may be performed in a different order than that described herein. Further, in some embodiments, a step in the method 1400 may be split into multiple sub-steps and performed by different entities, and/or multiple steps in the method 1400 may be combined into a single step.

The method 1400 may begin at step S1410 where multiple instances for the first RAN node may be triggered to be active simultaneously, such that a processing load at the first RAN node can be distributed among the multiple instances and a part of the processing load handled by an instance of the multiple instances can be taken over by at least one other instance of the multiple instances when the instance fails.

In some embodiments, for a reference point between the first RAN node and another RAN node, the multiple instances may comprise at least one of: a first instance that handles, as a master, both UE associated signaling and non-UE associated signaling for the reference point; and one or more second instances that handle only UE associated signaling for the reference point. In some embodiments, one of the multiple instances may be a master for a first reference point while another of the multiple instances may be a master for a second reference point. In some embodiments, for a reference point between the first RAN node and another RAN node, each of the multiple instances for the first RAN node may be associated with at least one network address for communicating with the other RAN node via the reference point.

In some embodiments, the step of triggering multiple instances for the first RAN node to be active may comprise: determining whether a number of currently active instances is less than a predetermined or configured value or not; and triggering at least one new instance for the first RAN node to be active in response to determining that the number of active instances is less than the predetermined or configured value. In some embodiments, the predetermined or configured value may be more than 2. In some embodiments, the predetermined or configured value may be 2. In some embodiments, after the step of triggering at least one new instance for the first RAN node to be active, the method 1400 may further comprise: transmitting, to each of one or more second RAN nodes, a first message indicating that a network address associated with the new instance is to be added at the corresponding second RAN node for the corresponding second RAN node to communicate with the first RAN node. In some embodiments, the first message may further indicate one of: the network address associated with the new instance may be used for UE associated signaling only when the new instance is not a master; and the network address associated with the new instance may be used for both UE associated signaling and non-UE associated signaling when the new instance is the master. In some embodiments, the first message may be transmitted by a first instance that handles, as a master, both UE associated signaling and non-UE associated signaling for a reference point between the first RAN node and the corresponding second RAN node. In some embodiments, when the new instance is an instance that is recovered from its previous failure, the first message may indicate that the network address associated with the new instance is used for UE associated signaling only no matter whether the new instance was previously a master or not.

In some embodiments, when the first RAN node is a gNB-CU-CP and the one or more second RAN nodes comprise a gNB-CU-UP, the first message transmitted to the gNB-CU-UP may be a GNB-CU-CP CONFIGURATION UPDATE message having a “TNLA Usage” IE with a value of “ue” for the network address associated with the new instance. In some embodiments, when the first RAN node is a gNB-CU-CP and the one or more second RAN nodes comprise a gNB-DU, the first message transmitted to the gNB-DU may be a GNB-CU CONFIGURATION UPDATE message having a “TNLA Usage” IE with a value of “ue” for the network address associated with the new instance.

In some embodiments, the method 1400 may further comprise: performing one or more operations between the multiple instances, the one or more operations comprising at least one of: synchronizing user data comprising UE contexts; monitoring peer's state; and internal routing for NGAP data. In some embodiments, the one or more operations may be performed via a synchronization channel between the multiple instances. In some embodiments, the method 1400 may further comprise: determining whether a first instance and/or a network interface associated with the first instance fails or not, the first instance handling, as a master, both UE associated signaling and non-UE associated signaling for the network interface; and triggering a second instance to function as the master and take over the non-UE associated signaling handled by the first instance in response to determining that the first instance and/or the network interface associated with the first instance fails. In some embodiments, the step of triggering the second instance to function as the master and take over the non-UE associated signaling handled by the first instance may comprise: transmitting, to each of one or more second RAN nodes, a second message indicating that a network address associated with the second instance, which was used for UE associated signaling only, is updated to be used for both UE associated signaling and non-UE associated signaling. In some embodiments, the second message may be transmitted by the second instance that is triggered to function as the master.

In some embodiments, when the first RAN node is a gNB-CU-CP and the one or more second RAN nodes comprise a gNB-CU-UP, the second message transmitted to the gNB-CU-UP may be a GNB-CU-CP CONFIGURATION UPDATE message having a “TNLA Usage” IE with a value of “both” for the network address associated with the second instance. In some embodiments, when the first RAN node is a gNB-CU-CP and the one or more second RAN nodes comprise a gNB-DU, the second message transmitted to the gNB-DU may be a GNB-CU CONFIGURATION UPDATE message having a “TNLA Usage” IE with a value of “both” for the network address associated with the second instance. In some embodiments, the method 1400 may further comprise: transmitting, to a CN node, a third message indicating that UE contexts associated with the first RAN node are to be retained by the CN node. In some embodiments, the third message may be transmitted by the second instance that is triggered to function as the master and is an NG SETUP REQUEST message having a “UE Retention Information” IE with a value of “ues-retained”.

FIG. 15 is a flow chart illustrating an exemplary method 1500 at a second RAN node for facilitating a first RAN node in enabling redundancy with multiple active instances according to an embodiment of the present disclosure. The method 1500 may be performed by a RAN node (e.g., the gNB-CU-UP 105-U or the gNB-DU 107). The method 1500 may comprise a step S1510. However, the present disclosure is not limited thereto. In some other embodiments, the method 1500 may comprise more steps, different steps, or any combination thereof. Further the steps of the method 1500 may be performed in a different order than that described herein. Further, in some embodiments, a step in the method 1500 may be split into multiple sub-steps and performed by different entities, and/or multiple steps in the method 1500 may be combined into a single step.

The method 1500 may begin at step S1510 where the second RAN node may communicate with at least one of multiple instances for the first RAN node that are active simultaneously, to enable the first RAN node to distribute its processing load among the multiple instances and a part of the processing load handled by an instance of the multiple instances can be taken over by at least one other instance of the multiple instances when the instance fails.

In some embodiments, for a reference point between the first RAN node and the second RAN node, the multiple instances may comprise at least one of: a first instance that handles, as a master, both UE associated signaling and non-UE associated signaling for the reference point; and one or more second instances that handle only UE associated signaling for the reference point. In some embodiments, one of the multiple instances may be a master for a first reference point while another of the multiple instances may be a master for a second reference point. In some embodiments, for a reference point between the first RAN node and the second RAN node, each of the multiple instances for the first RAN node may be associated with at least one network address for communicating with the second RAN node via the reference point. In some embodiments, the number of the multiple instances may be 2. In some embodiments, the number of the multiple instances may be greater than 2. In some embodiments, the method 1500 may further comprise: receiving, from the first RAN node, a first message indicating that a network address associated with a new instance for the first RAN node is to be added at the second RAN node for the second RAN node to communicate with the first RAN node.

In some embodiments, the first message 1500 may further indicate one of: the network address associated with the new instance is used for UE associated signaling only when the new instance is not a master; and the network address associated with the new instance is used for both UE associated signaling and non-UE associated signaling when the new instance is the master. In some embodiments, the first message may be transmitted by a first instance that handles, as a master, both UE associated signaling and non-UE associated signaling for a reference point between the first RAN node and the second RAN node. In some embodiments, when the new instance is an instance that is recovered from its previous failure, the first message may indicate that the network address associated with the new instance is used for UE associated signaling only no matter whether the new instance was previously a master or not. In some embodiments, when the first RAN node is a gNB-CU-CP and the second RAN node is a gNB-CU-UP, the first message may be a GNB-CU-CP CONFIGURATION UPDATE message having a “TNLA Usage” IE with a value of “ue” for the network address associated with the new instance. In some embodiments, when the first RAN node is a gNB-CU-CP and the second RAN node is a gNB-DU, the first message may be a GNB-CU CONFIGURATION UPDATE message having a “TNLA Usage” IE with a value of “ue” for the network address associated with the new instance.

In some embodiments, the method 1500 may further comprise: receiving, from the first RAN node, a second message indicating that a network address associated with a second instance, which was used for UE associated signaling only, is updated to be used for both UE associated signaling and non-UE associated signaling. In some embodiments, the second message may be transmitted by the second instance. In some embodiments, when the first RAN node is a gNB-CU-CP and the second RAN node is a gNB-CU-UP, the second message may be a GNB-CU-CP CONFIGURATION UPDATE message having a“TNLA Usage” IE with a value of “both” for the network address associated with the second instance. In some embodiments, when the first RAN node is a gNB-CU-CP and the second RAN node is a gNB-DU, the second message may be a GNB-CU CONFIGURATION UPDATE message having a “TNLA Usage” IE with a value of “both” for the network address associated with the second instance.

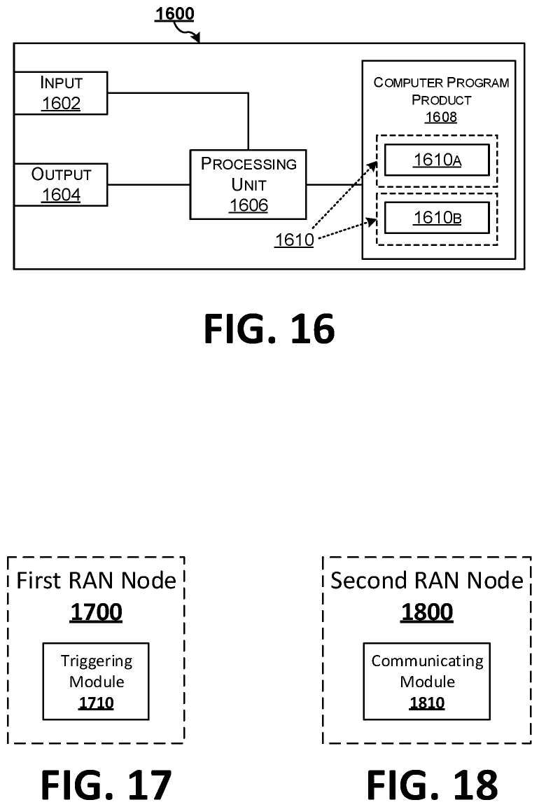

FIG. 16 schematically shows an embodiment of an arrangement which may be used in one or more RAN nodes (e.g., gNB-DU 107, gNB-CU-CP 105-C, and/or gNB-CU-UP 105-U) according to an embodiment of the present disclosure. Comprised in the arrangement 1600 are a processing unit 1606, e.g., with a Digital Signal Processor (DSP) or a Central Processing Unit (CPU). The processing unit 1606 may be a single unit or a plurality of units to perform different actions of procedures described herein. The arrangement 1600 may also comprise an input unit 1602 for receiving signals from other entities, and an output unit 1604 for providing signal(s) to other entities. The input unit 1602 and the output unit 1604 may be arranged as an integrated entity or as separate entities.

Furthermore, the arrangement 1600 may comprise at least one computer program product 1608 in the form of a non-volatile or volatile memory, e.g., an Electrically Erasable Programmable Read-Only Memory (EEPROM), a flash memory and/or a hard drive. The computer program product 1608 comprises a computer program 1610, which comprises code/computer readable instructions, which when executed by the processing unit 1606 in the arrangement 1600 causes the arrangement 1600 and/or the network node(s) in which it is comprised to perform the actions, e.g., of the procedure described earlier in conjunction with FIG. 3 through FIG. 15 or any other variant.

The computer program 1610 may be configured as a computer program code structured in a computer program module 1610A. Hence, in an exemplifying embodiment when the arrangement 1600 is used in a first RAN node for enabling redundancy with multiple active instances, the code in the computer program of the arrangement 1600 includes: a module 1610A configured to trigger multiple instances for the first RAN node to be active simultaneously, such that a processing load at the first RAN node can be distributed among the multiple instances and a part of the processing load handled by an instance of the multiple instances can be taken over by at least one other instance of the multiple instances when the instance fails.

Additionally or alternatively, the computer program 1610 may be configured as a computer program code structured in a computer program module 1610B. Hence, in an exemplifying embodiment when the arrangement 1600 is used in a second RAN node for facilitating a first RAN node in enabling redundancy with multiple active instances, the code in the computer program of the arrangement 1600 includes: a module 1610B configured to communicate with at least one of multiple instances for the first RAN node that are active simultaneously, to enable the first RAN node to distribute its processing load among the multiple instances and a part of the processing load handled by an instance of the multiple instances can be taken over by at least one other instance of the multiple instances when the instance fails.

The computer program modules could essentially perform the actions of the flow illustrated in FIG. 3 through FIG. 15, to emulate the RAN node(s). In other words, when the different computer program modules are executed in the processing unit 1606, they may correspond to different modules in the RAN node(s).

Although the code means in the embodiments disclosed above in conjunction with FIG. 16 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the RAN node(s).

Correspondingly to the method 1400 as described above, an exemplary first RAN node for enabling redundancy with multiple active instances is provided. FIG. 17 is a block diagram of a first RAN node 1700 according to an embodiment of the present disclosure. The first network node 1700 may be, e.g., the gNB-CU-CP 105-C in some embodiments.

The first RAN node 1700 may be configured to perform the method 1400 as described above in connection with FIG. 14. As shown in FIG. 17, the first RAN node 1700 may comprise a triggering module 1710 configured to trigger multiple instances for the first RAN node to be active simultaneously, such that a processing load at the first RAN node can be distributed among the multiple instances and a part of the processing load handled by an instance of the multiple instances can be taken over by at least one other instance of the multiple instances when the instance fails.

The above module 1710 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 14. Further, the first RAN node 1700 may comprise one or more further modules, each of which may perform any of the steps of the method 1400 described with reference to FIG. 14.

Correspondingly to the method 1500 as described above, an exemplary second RAN node for facilitating a first RAN node in enabling redundancy with multiple active instances is provided. FIG. 18 is a block diagram of a second RAN node 1800 according to an embodiment of the present disclosure. The second network node 1800 may be, e.g., the gNB-CU-UP 105-U or the gNB-DU 107 in some embodiments.

The second RAN node 1800 may be configured to perform the method 1500 as described above in connection with FIG. 15. As shown in FIG. 18, the second RAN node 1800 may comprise a communicating module 1810 configured to communicate with at least one of multiple instances for the first RAN node that are active simultaneously, to enable the first RAN node to distribute its processing load among the multiple instances and a part of the processing load handled by an instance of the multiple instances can be taken over by at least one other instance of the multiple instances when the instance fails.

The above module 1810 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 15. Further, the second RAN node 1800 may comprise one or more further modules, each of which may perform any of the steps of the method 1500 described with reference to FIG. 15.

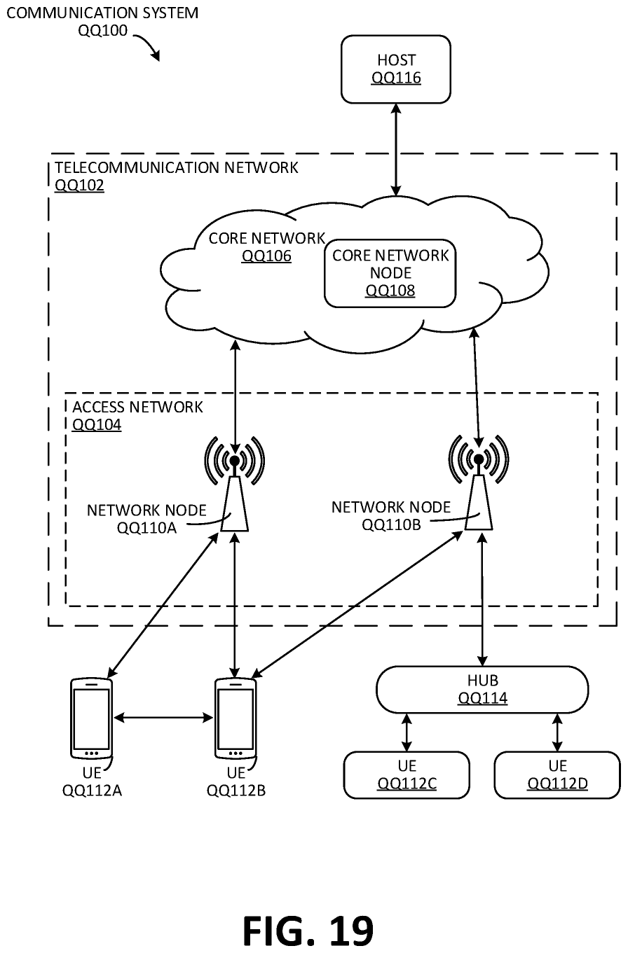

FIG. 19 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 19 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

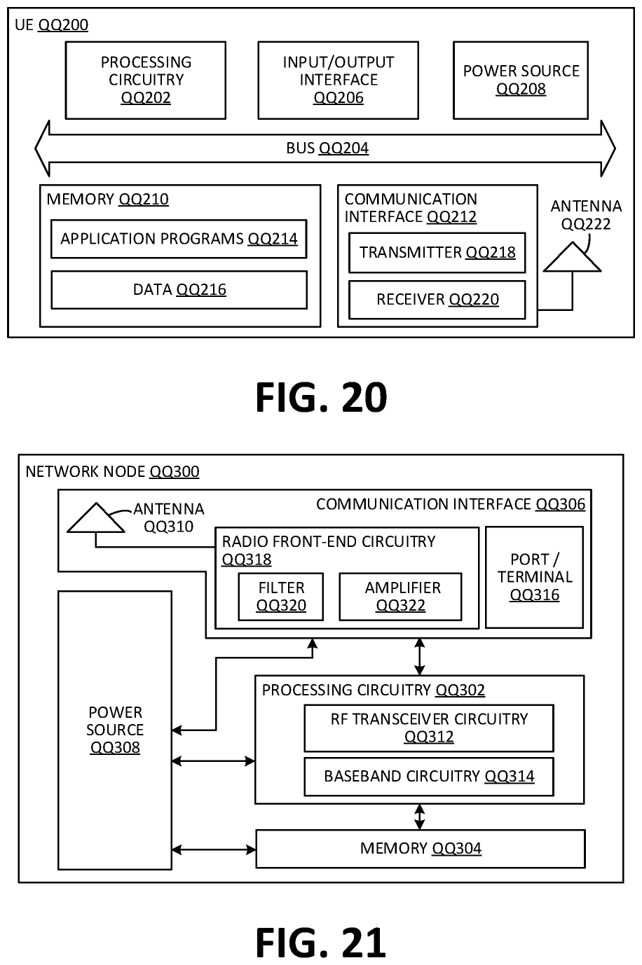

FIG. 20 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 20. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAS), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 20.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 21 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 21 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

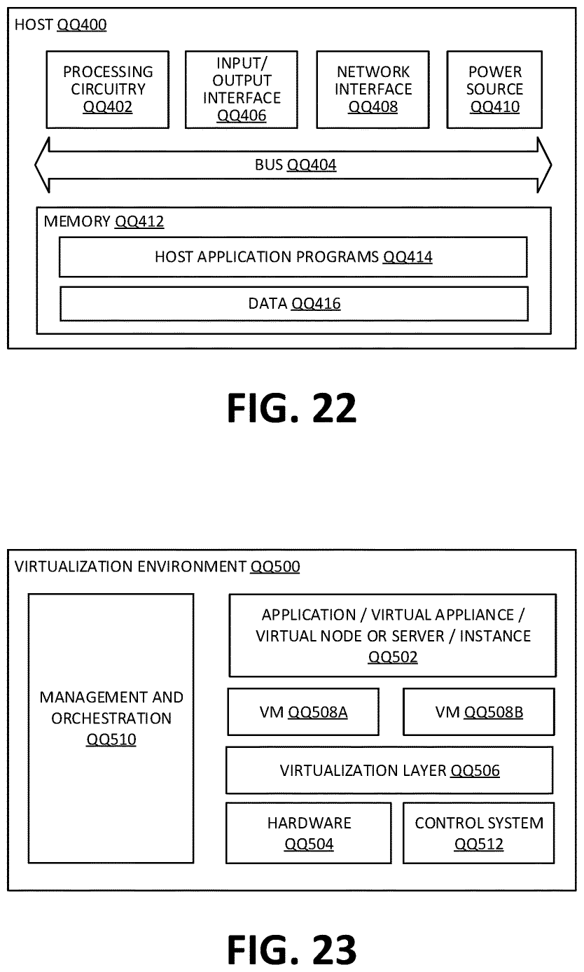

FIG. 22 is a block diagram of a host QQ400, which may be an embodiment of the host QQ116 of FIG. 19, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIG. 20 and FIG. 21, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 23 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment QQ500 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

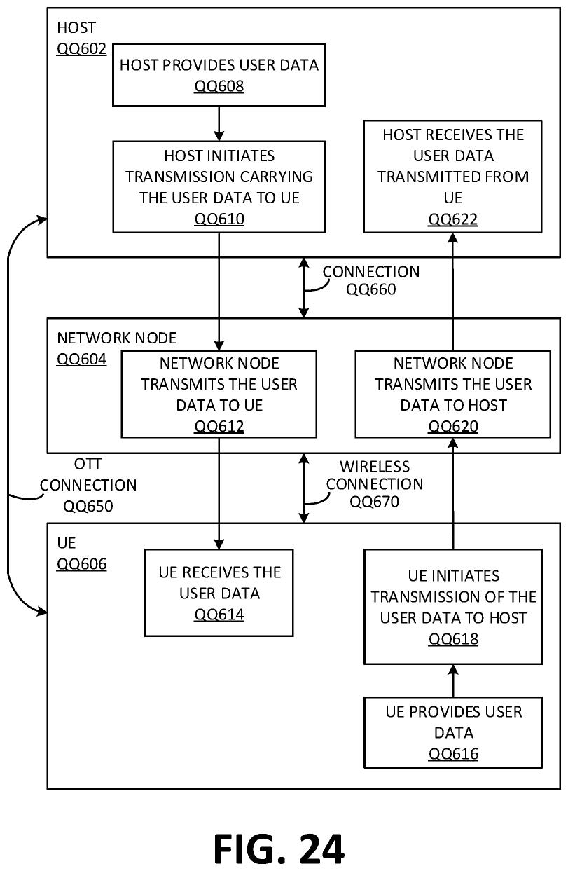

FIG. 24 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 19 and/or UE QQ200 of FIG. 20), network node (such as network node QQ110a of FIG. 19 and/or network node QQ300 of FIG. 21), and host (such as host QQ116 of FIG. 19 and/or host QQ400 of FIG. 22) discussed in the preceding paragraphs will now be described with reference to FIG. 24.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 19) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the data rate, latency, power consumption and thereby provide benefits such as reduced user waiting time, relaxed restriction on file size, improved content resolution, better responsiveness, extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| AMF | Access and Mobility management Function |
| PNF | Physical Network Function |
| CNF | Cloud Network Function |
| E1AP | E1 Application Protocol |
| F1AP | F1 Application Protocol |
| NGAP | NG Application Protocol |
| CP | Control Plane |
| UP | User Plane |
| TNLA | Transport Network Layer Association |

1. A method at a first Radio Access Network (RAN) node for enabling redundancy with multiple active instances, the method comprising:
triggering multiple instances for the first RAN node to be active simultaneously, such that a processing load at the first RAN node can be distributed among the multiple instances and a part of the processing load handled by an instance of the multiple instances can be taken over by at least one other instance of the multiple instances when the instance fails.

2. The method of claim 1, wherein for a reference point between the first RAN node and another RAN node, the multiple instances comprise at least one of:
a first instance that handles, as a master, both User Equipment (UE) associated signaling and non-UE associated signaling for the reference point; and
one or more second instances that handle only UE associated signaling for the reference point,
wherein for the reference point between the first RAN node and another RAN node, each of the multiple instances for the first RAN node is associated with at least one network address for communicating with the other RAN node via the reference point.

3. The method of claim 2, wherein one of the multiple instances is a master for a first reference point while another of the multiple instances is a master for a second reference point.

4. (canceled)

5. The method of claim 1, wherein the step of triggering multiple instances for the first RAN node to be active comprises:
determining whether a number of currently active instances is less than a predetermined or configured value or not; and
triggering at least one new instance for the first RAN node to be active in response to determining that the number of active instances is less than the predetermined or configured value.

6. (canceled)

7. The method of claim 5, wherein after the step of triggering at least one new instance for the first RAN node to be active, the method further comprises:
transmitting, to each of one or more second RAN nodes, a first message indicating that a network address associated with the new instance is to be added at the corresponding second RAN node for the corresponding second RAN node to communicate with the first RAN node.

8. The method of claim 7, wherein the first message further indicates one of:
the network address associated with the new instance is used for UE associated signaling only when the new instance is not a master; and
the network address associated with the new instance is used for both UE associated signaling and non-UE associated signaling when the new instance is the master,
wherein the first message is transmitted by a first instance that handles, as a master, both UE associated signaling and non-UE associated signaling for a reference point between the first RAN node and the corresponding second RAN node; and
wherein when the new instance is an instance that is recovered from its previous failure, the first message indicates that the network address associated with the new instance is used for UE associated signaling only no matter whether the new instance was previously a master or not.

9.-10. (canceled)

11. The method of claim 7, wherein when the first RAN node is a gNB Central Unit Control Plane (gNB-CU-CP) and the one or more second RAN nodes comprise a gNB Central Unit User Plane (gNB-CU-UP), the first message transmitted to the gNB-CU-UP is a GNB-CU-CP CONFIGURATION UPDATE message having a “TNLA Usage” Information Element (IE) with a value of “ue” for the network address associated with the new instance.

12. The method of claim 7, wherein when the first RAN node is a gNB-CU-CP and the one or more second RAN nodes comprise a gNB Distributed Unit (gNB-DU), the first message transmitted to the gNB-DU is a GNB-CU CONFIGURATION UPDATE message having a “TNLA Usage” IE with a value of “ue” for the network address associated with the new instance.

13. The method of claim 1, further comprising:
performing one or more operations between the multiple instances, the one or more operations comprising at least one of:
synchronizing user data comprising UE contexts;
monitoring peer's state; and
internal routing for Next Generation Application Protocol (NGAP) data;
wherein the one or more operations are performed via a synchronization channel between the multiple instances.

14. (canceled)

15. The method of claim 1, further comprising:
determining whether at least one of a first instance and a network interface associated with the first instance fails or not, the first instance handling, as a master, both UE associated signaling and non-UE associated signaling for the network interface; and
triggering a second instance to function as the master and take over the non-UE associated signaling handled by the first instance in response to determining that at least one of the first instance and the network interface associated with the first instance fails.

16. The method of claim 15, wherein the step of triggering the second instance to function as the master and take over the non-UE associated signaling handled by the first instance comprises:
transmitting, to each of one or more second RAN nodes, a second message indicating that a network address associated with the second instance, which was used for UE associated signaling only, is updated to be used for both UE associated signaling and non-UE associated signaling,
wherein the second message is transmitted by the second instance that is triggered to function as the master; and
wherein when the first RAN node is a gNB-CU-CP and the one or more second RAN nodes comprise a gNB-CU-UP, the second message transmitted to the gNB-CU-UP is a GNB-CU-CP CONFIGURATION UPDATE message having a “TNLA Usage” IE with a value of “both” for the network address associated with the second instance; and
wherein when the first RAN node is a gNB-CU-CP and the one or more second RAN nodes comprise a gNB-DU, the second message transmitted to the gNB-DU is a GNB-CU CONFIGURATION UPDATE message having a “TNLA Usage” IE with a value of “both” for the network address associated with the second instance.

17.-19. (canceled)

20. The method of claim 15, further comprising:
transmitting, to a core network (CN) node, a third message indicating that UE contexts associated with the first RAN node are to be retained by the CN node;
wherein the third message is transmitted by the second instance that is triggered to function as the master and is an NG SETUP REQUEST message having a “UE Retention Information” IE with a value of “ues-retained”.

21. (canceled)

22. A first RAN node, comprising:
a processor;
a memory storing instructions which, when executed by the processor, cause the processor to perform the method of claim 1;
wherein the first RAN node is a gNB-CU-CP.

23. (canceled)

24. A method at a second RAN node for facilitating a first RAN node in enabling redundancy with multiple active instances, the method comprising:
communicating with at least one of multiple instances for the first RAN node that are active simultaneously, to enable the first RAN node to distribute its processing load among the multiple instances and a part of the processing load handled by an instance of the multiple instances can be taken over by at least one other instance of the multiple instances when the instance fails.

25. The method of claim 24, wherein for a reference point between the first RAN node and the second RAN node, the multiple instances comprise at least one of:
a first instance that handles, as a master, both UE associated signaling and non-UE associated signaling for the reference point; and
one or more second instances that handle only UE associated signaling for the reference point;
wherein one of the multiple instances is a master for a first reference point while another of the multiple instances is a master for a second reference point; and
wherein for a reference point between the first RAN node and the second RAN node, each of the multiple instances for the first RAN node is associated with at least one network address for communicating with the second RAN node via the reference point.

26.-28. (canceled)

29. The method of claim 24, further comprising:
receiving, from the first RAN node, a first message indicating that a network address associated with a new instance for the first RAN node is to be added at the second RAN node for the second RAN node to communicate with the first RAN node.

30. The method of claim 29, wherein the first message further indicates one of:
the network address associated with the new instance is used for UE associated signaling only when the new instance is not a master; and
the network address associated with the new instance is used for both UE associated signaling and non-UE associated signaling when the new instance is the master,
wherein the first message is transmitted by a first instance that handles, as a master, both UE associated signaling and non-UE associated signaling for a reference point between the first RAN node and the second RAN node.

31. (canceled)

32. The method of claim 29, wherein when the new instance is an instance that is recovered from its previous failure, the first message indicates that the network address associated with the new instance is used for UE associated signaling only no matter whether the new instance was previously a master or not,
wherein when the first RAN node is a gNB-CU-CP and the second RAN node is a gNB-CU-UP, the first message is a GNB-CU-CP CONFIGURATION UPDATE message having a “TNLA Usage” IE with a value of “ue” for the network address associated with the new instance; and
wherein when the first RAN node is a gNB-CU-CP and the second RAN node is a gNB-DU, the first message is a GNB-CU CONFIGURATION UPDATE message having a “TNLA Usage” IE with a value of “ue” for the network address associated with the new instance.

33.-34. (canceled)

35. The method of claim 24, further comprising:
receiving, from the first RAN node, a second message indicating that a network address associated with a second instance, which was used for UE associated signaling only, is updated to be used for both UE associated signaling and non-UE associated signaling;
wherein the second message is transmitted by the second instance.

36. (canceled)

37. The method of claim 34, wherein when the first RAN node is a gNB-CU-CP and the second RAN node is a gNB-CU-UP, the second message is a GNB-CU-CP CONFIGURATION UPDATE message having a “TNLA Usage” IE with a value of “both” for the network address associated with the second instance,
wherein when the first RAN node is a gNB-CU-CP and the second RAN node is a gNB-DU, the second message is a GNB-CU CONFIGURATION UPDATE message having a “TNLA Usage” IE with a value of “both” for the network address associated with the second instance.

38.-43. (canceled)
